(19) United States
(12) Patent Application Publication
(10) Pub. No.: US 2021/0309471 A1
(43) Pub. Date: Oct. 7, 2021

(54) PAPER SHEET HANDLING APPARATUS AND TRANSPORTATION MEMBER

(71) Applicant: FUJITSU FRONTECH LIMITED, Tokyo (JP)

(72) Inventors: Daiki HARAI, Inagi (JP); Koichi HOSOYAMA, Inagi (JP); Tomoyuki TAMAHASHI, Inagi (JP); Isamu ESAKI, Inagi (JP); Hiroshi YANAGIDA, Inagi (JP); Tatsuya SHIMAMURA, Inagi (JP)

(21) Appl. No.: 17/352,974

(22) Filed: Jun. 21, 2021

Related U.S. Application Data
(63) Continuation of application No. PCT/JP2019/001304, filed on Jan. 17, 2019.

(51) Int. Cl. B65H 3/06

(52) U.S. Cl. CPC B65H 3/0638; B65H 2404/111

(57) ABSTRACT

A paper sheet handling apparatus includes a transportation member that transports a paper sheet and a rotation shaft member that serves as a center of rotation of the transportation member, wherein the transportation member includes a plurality of elastic loop sections having central axes parallel to the rotation shaft member, and the plurality of loop sections are arranged in a rotation direction of the transportation member such that the plurality of loop sections are each supported by an adjacent loop section when being elastically deformed while contacting the paper sheet.

### CROSS-REFERENCE TO RELATED APPLICATION

This application is continuation application of International Application PCT/JP2019/001304 filed on Jan. 17 2019 and designated the U.S., the entire contents of which are incorporated herein by reference.

### FIELD OF THE INVENTION

The present invention relates to a transportation member for transporting a paper sheet, and a paper sheet handling apparatus including the transportation member.

### BACKGROUND OF THE INVENTION

A conventional technique for feeding manuscript paper by using blade parts radially extending from a rotation shaft is known. A separation roller provided with blade parts formed like loops is also known (see, for example, Japanese Laid-open Patent Publication No. 2-8124).

A proposed paper-sheet collection and feeding-out apparatus includes elastic blade parts radially extending from a rotation shaft and an elastic support part supporting the elastic blade parts, wherein the elastic support part includes a bent portion bent along the shape of the elastic blade parts, one end of the bent portion is connected to an outer peripheral surface adjacent to one of the elastic blade parts, and the other end of the bent portion is connected to the base end portion of another of the elastic blade parts (see, for example, Japanese Patent No. 5119133).

### BRIEF SUMMARY OF THE INVENTION

In one aspect, a paper sheet handling apparatus includes a transportation member that transports a paper sheet, a rotation shaft member that serves as a center of rotation of the transportation member, wherein the transportation member includes a plurality of elastic loop sections having central axes parallel to the rotation shaft member, and the plurality of loop sections are arranged in a rotation direction of the transportation member such that the plurality of loop sections are each supported by an adjacent loop section when being elastically deformed while contacting the paper sheet.

In another aspect, a transportation member transports a paper sheet and includes a plurality of elastic loop sections having central axes parallel to a rotation shaft member that serves as a center of rotation of the transportation member, and the plurality of loop sections are arranged in a rotation direction of the transportation member such that the plurality of loop sections are each supported by an adjacent loop section when being elastically deformed while contacting the paper sheet.

The object and advantages of the present invention will be realized by the elements set forth in the claims or combinations thereof.

### BRIEF DESCRIPTION OF THE SEVERAL VIEWS OF THE DRAWINGS

FIG. 1 is a left side view illustrating a paper sheet handling apparatus in accordance with a first embodiment;

FIG. 2A is a right-side perspective view illustrating the internal structures of a top module and a drawing-in and recycling module in a first embodiment (example 1);

FIG. 2B is a right-side perspective view illustrating the internal structures of a top module and a drawing-in and recycling module in a first embodiment (example 2);

FIG. 3A is a right-side perspective view illustrating a transportation member, a rotation shaft member, and transportation rollers in a first embodiment;

FIG. 3B is a plan view illustrating a transportation member, a rotation shaft member, and transportation rollers in a first embodiment;

FIG. 4A is a right side view illustrating a transportation member in accordance with a first embodiment;

FIG. 4B is a right-side perspective view illustrating a transportation member in accordance with a first embodiment;

FIG. 4C is a left-side perspective view illustrating a transportation member in accordance with a first embodiment;

FIG. 4D is a back view illustrating a transportation member in accordance with a first embodiment;

FIG. 5A is a left side view illustrating a transportation member in accordance with a second embodiment;

FIG. 5B is a right-side perspective view illustrating a transportation member in accordance with a second embodiment;

FIG. 5C is a left-side perspective view illustrating a transportation member in accordance with a second embodiment;

FIG. 5D is a back view illustrating a transportation member in accordance with a second embodiment;

FIG. 6A is a right side view illustrating a transportation member in accordance with a third embodiment; and

FIG. 6B is a back view illustrating a transportation member in accordance with a third embodiment.

### DETAILED DESCRIPTION OF THE INVENTION

In the meantime, paper sheets such as bills are typically transported while being sandwiched between a driving roller (or a driving belt) and a driven roller. At a site where a member such as a magnetic line sensor is provided in the vicinity of paper sheets, however, the paper sheets cannot be transported while being sandwiched between a driving roller and a driven roller.

Accordingly, a transportation member facing the magnetic line sensor does not face the drive roller and thus needs to have a high transporting force.

However, looped blade parts such as those described above have elasticity and will be elastically deformed for transportation, so it will be difficult to allow the blade parts to have a high transporting force for transporting paper sheets. Likewise, when elastic blade parts and an elastic support part such as those described above are used, it will be difficult to allow the elastic blade parts and the elastic support part to have a high transporting force for transporting paper sheets since the elastic support part will be elastically deformed, as with the elastic blade parts.

By referring to the drawings, the following describes a paper sheet handling apparatus and a transportation member in accordance with first to third embodiments of the present invention.

### First Embodiment

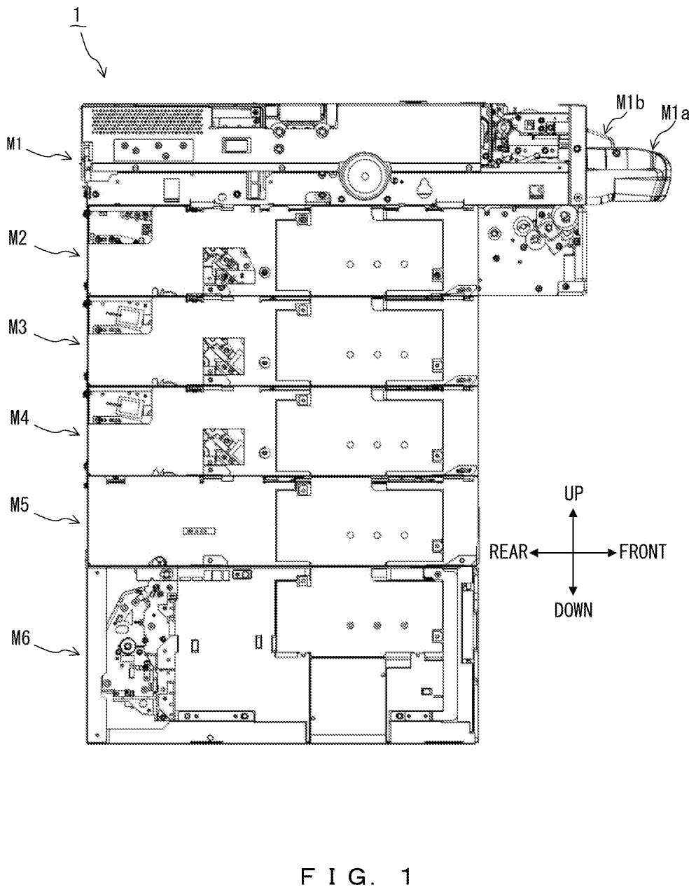

FIG. 1 is a left side view illustrating a paper sheet handling apparatus 1.

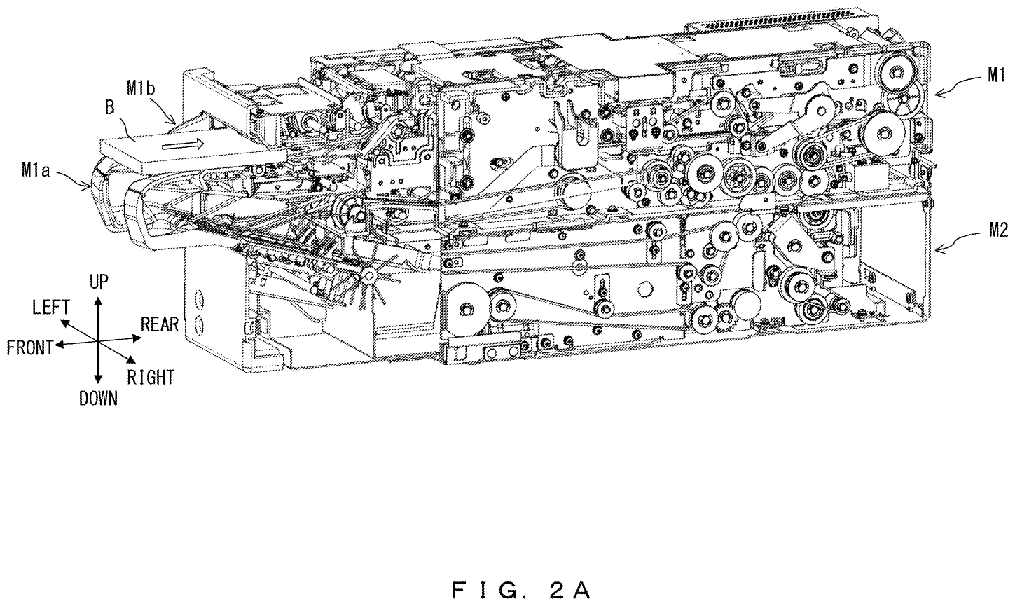

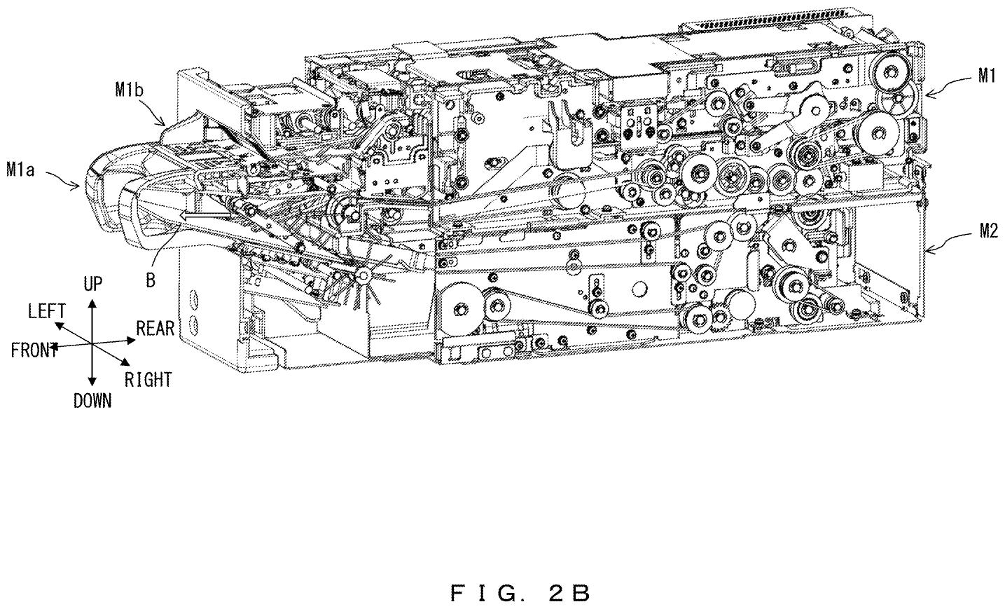

FIGS. 2A and 2B are right-side perspective views illustrating the internal structures of a top module M1 and a drawing-in and recycling module M2 of the paper sheet handling apparatus 1.

FIGS. 1-2B and FIGS. 3A-6B (described hereinafter) indicate a front-rear direction, a left-right direction, and an up-down direction for descriptive purposes. As an example, the front-rear and left-right directions may be horizontal directions, and the up-down direction may be a vertical direction.

As depicted in FIG. 1, the paper sheet handling apparatus 1 includes, in the following order from the upper side, a top module M1, a drawing-in and recycling module M2, recycling modules M3 and M4, a replenishment module M5, and a collection module M6.

The top module M1 is provided with a forwardly protruding money insertion unit M1b for inserting a bill B at a money insertion position, as indicated in FIG. 2A, and a forwardly protruding money ejection unit M1a for ejecting a bill B at a money ejection position, as indicated in FIG. 2B. Note that the bills B are examples of paper sheets. The paper sheets are not limited to the bills B but may be continuous forms, expense sheets, or flat paper. In such a case, the money ejection unit M1b will function as an ejector, and the money insertion unit M1a will function as an inserter.

A transportation unit for transporting a bill B and a validation unit for validating the bill B are disposed inside the top module M1.

When a customer has forgotten to take a bill B ejected on the money ejection unit M1b and the remaining of the bill B is sensed, the drawing-in and recycling module M2 transports and draws the remaining bill B into a front portion.

For example, a rear portion of the drawing-in and recycling module M2 and front portions and rear portions of the recycling modules M3 and M4 may each have disposed therein a recycle bill accommodation unit (not illustrated) for accommodating bills B sandwiched between films in a winding manner.

The replenishment module M5 accommodate bills B to be ejected.

The collection module M6 collects bills B not to be recycled among inserted bills B.

The above configuration of the paper sheet handling apparatus 1 is nothing but an example, and any configuration can be used as long as the paper sheet handling apparatus 1 includes a transportation unit for transporting bills B or a processing unit for performing some sort of processing on bills B, such as validation or examination.

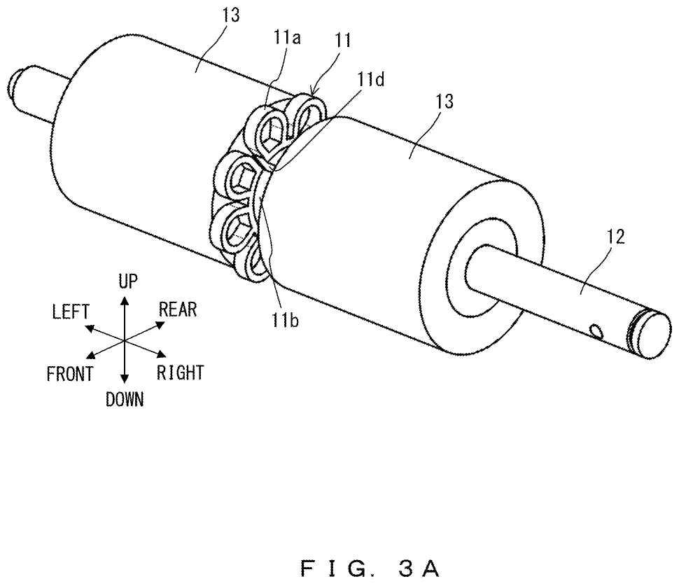

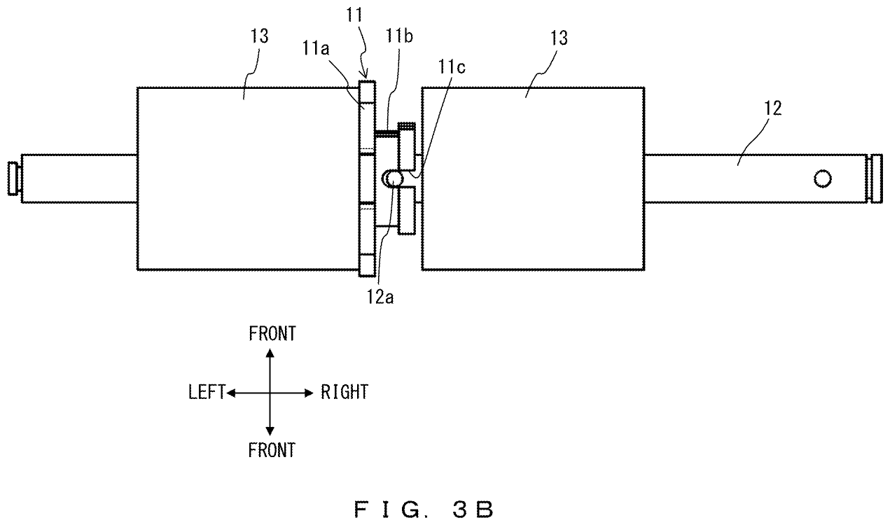

FIGS. 3A and 3B are a right-side perspective view and a plan view illustrating a transportation member 11, a rotation shaft member 12, and transportation rollers 13.

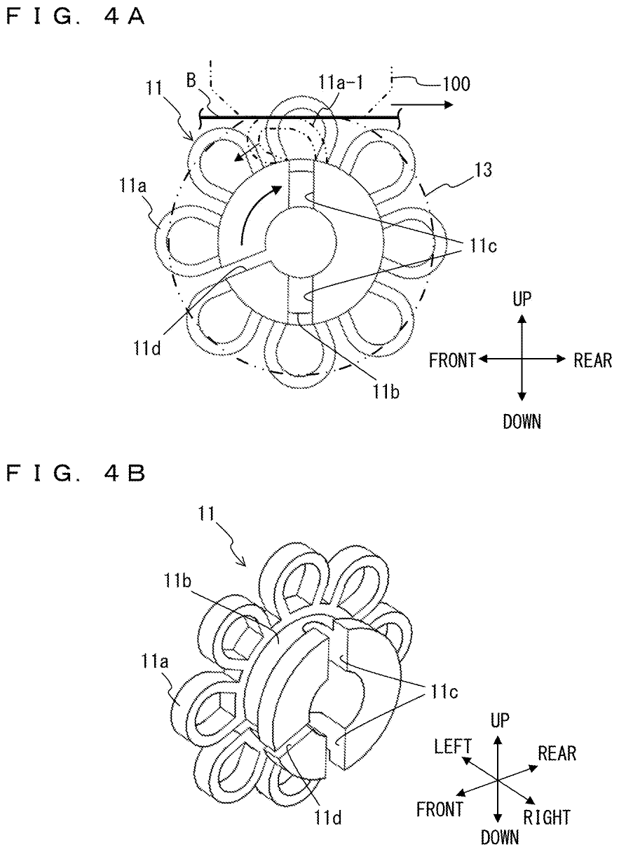

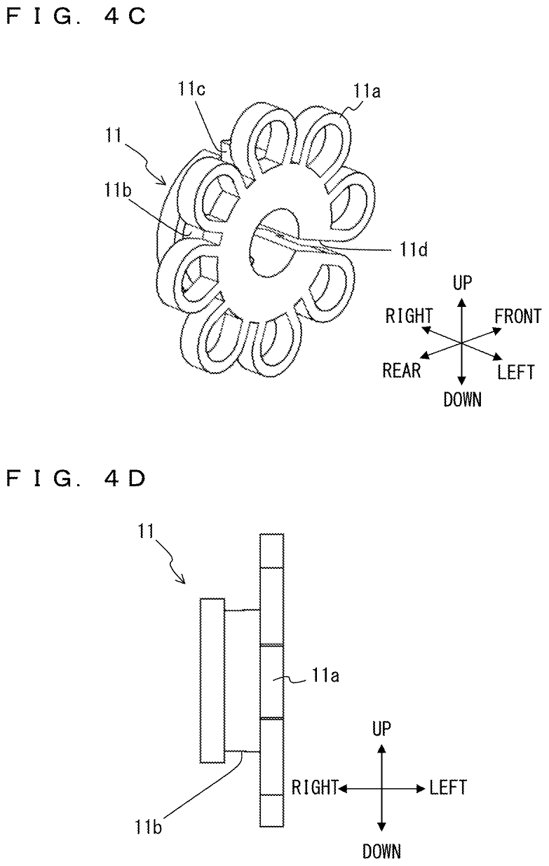

FIGS. 4A-4D are a right side view, a right-side perspective view, a left-side perspective view, and a back view illustrating a transportation member 11.

For example, the transportation member 11, the rotation shaft member 12, and the transportation rollers 13 depicted in FIGS. 3A and 3B may be disposed within the top module M1.

The transportation member 11 includes, as depicted in FIGS. 4A-4C, a plurality of (e.g., eight) elastic loop sections 11a and transports a bill B depicted in FIG. 4A. The transportation member 11 is formed from an elastic member, e.g., rubber.

The plurality of loop sections 11a have central axes parallel to the rotation shaft member 12 and come into contact with a bill B. Accordingly, empty spaces extend completely through the plurality of loop sections 11a in the left-right direction in FIGS. 4A-4C.

As depicted in FIG. 4A, the plurality of loop sections 11a are arranged in the rotation direction of the transportation member 11 such that the plurality of loop sections 11a are each supported by an adjacent loop section 11a when being elastically deformed (see the loop section 11a-1 indicated by two-dot dash lines) while contacting a bill B sandwiched between the loop section 11a and a magnetic line sensor 100 indicated by a two-dot dash line. When a loop section 11a is in contact with the magnetic line sensor 100 with or without a bill B therebetween, deformation and slippage will occur, but the loop section 11a will come into contact with, and thus be supported by, the adjacent (subsequent) elastic loop section 11a, thereby increasing the transportation performance.

The magnetic line sensor 100 is an example of a facing member disposed to face the transportation member 11. The facing member is not a transportation member such as a drive roller but is a member that does not have a transporting force, such as a transportation guide plate.

A bill B is desirably transported toward the magnetic line sensor 100 with the leading edge portion thereof sandwiched between two adjacent loop sections 11a. In this way, if the bill B is transported with the leading edge portion thereof staying away from the magnetic line sensor 100, the two adjacent loop sections 11a can hold up the bill B toward the magnetic line sensor 100. Thus, jamming of the bill B can be suppressed. In a case where the transportation member 11 provided with the loop sections 11a in accordance with the first embodiment is not provided and the transportation roller 13 alone transports a bill B, if the bill B is transported with the leading edge portion thereof staying away from the magnetic line sensor 100, the bill B will contact the transportation roller 13 and thus could cause a jam.

Two adjacent loop sections 11a have therebetween a spacing in the rotation direction but may be provided continuously without a spacing therebetween.

As depicted in FIGS. 4B and 4D, the transportation member 11 is provided with a bundling groove 11b. A bundling member such as a bundling band (not illustrated) is inserted into the bundling groove 11b. The bundling member fixes the transportation member 11 to the rotation shaft member 12 by being wound in the bundling groove 11b.

As depicted in FIGS. 4A and 4B, the right side surface of the transportation member 11 is provided with a positioning groove 11c extending in the radial direction (the up-down direction in FIGS. 4A and 4B) across the transportation member 11. Two positioning pins 12a protruding from the rotation shaft member 12 depicted in FIGS. 3A and 3B toward opposite sides are inserted into the positioning groove 11c. Thus, the transportation member 11 rotates integrally with the rotation shaft member 12 with the positioning thereof in the rotation direction attained with respect to the rotation shaft member 12.

As depicted in FIGS. 4A and 4C, the transportation member 11 is provided with a notch 11d for allowing the transportation member 11 to be attached to the rotation shaft member 12 in a detachable manner. Two portions of the transportation member 11 sandwiching the notch 11d are separated in the rotation direction.

The transportation member 11 has elasticity and thus can be detached from the rotation shaft member 12 while, for example, the notch 11d is being expanded by hand. Meanwhile, the transportation member 11 can be attached to the rotation shaft member 12 while, for example, the notch 11d is being expanded by hand.

The transportation rollers 13 depicted in FIGS. 3A and 3B rotate together with the transportation member 11, with the rotation shaft member 12 as the center of rotation. As an example, two transportation rollers 13 may be disposed sandwiching the transportation member 11. The two transportation rollers 13 and the single transportation member 11 are disposed facing the magnetic line sensor 100 depicted in FIG. 4A.

A plurality of transportation members 11 may be disposed on the single rotation shaft member 12. The loop sections 11a protrude in the radial direction beyond the outer peripheral surface of the transportation roller 13 indicated by a two-dot dash line in FIG. 4A. The transportation roller 13 is desirably an elastic roller and may be, for example, a brush roller.

In the first embodiment, the paper sheet handling apparatus 1 includes: the transportation member 11 that transports a bill B, i.e., an example of the paper sheet; and the rotation shaft member 12 that serves as a center of rotation of the transportation member 11, wherein the transportation member 11 includes the plurality of elastic loop sections 11a having central axes parallel to the rotation shaft member 12, and the plurality of loop sections 11a are arranged in the rotation direction of the transportation member 11 such that the plurality of loop sections 11a are each supported by an adjacent loop section 11a when being elastically deformed while contacting the bill B. Thus, the loop section 11a supported by an adjacent loop section 11a can transport the bill B while being elastically deformed, so that the bill B can be transported with a high transporting force.

In the first embodiment, the paper sheet handling apparatus 1 further includes the transportation rollers 13 that rotate together with the transportation member 11, with the rotation shaft member 12 as the center of rotation, and the plurality of loop sections 11a protrude in the radial direction beyond the outer peripheral surface of each of the transportation rollers 13. Thus, the bill B can be transported by the transportation rollers 13 and the transportation member 11 that includes the loop sections 11a, so that the bill B can be transported with a higher transporting force.

In the first embodiment, the transportation member 11 is provided with the notch 11d for allowing the transportation member 11 to be attached to the rotation shaft member 12 in a detachable manner, and two portions of the transportation member 11 sandwiching the notch 11d are separated in the rotation direction. Thus, the transportation member 11 can be easily attached to and detached from the rotation shaft member 12.

### Second Embodiment

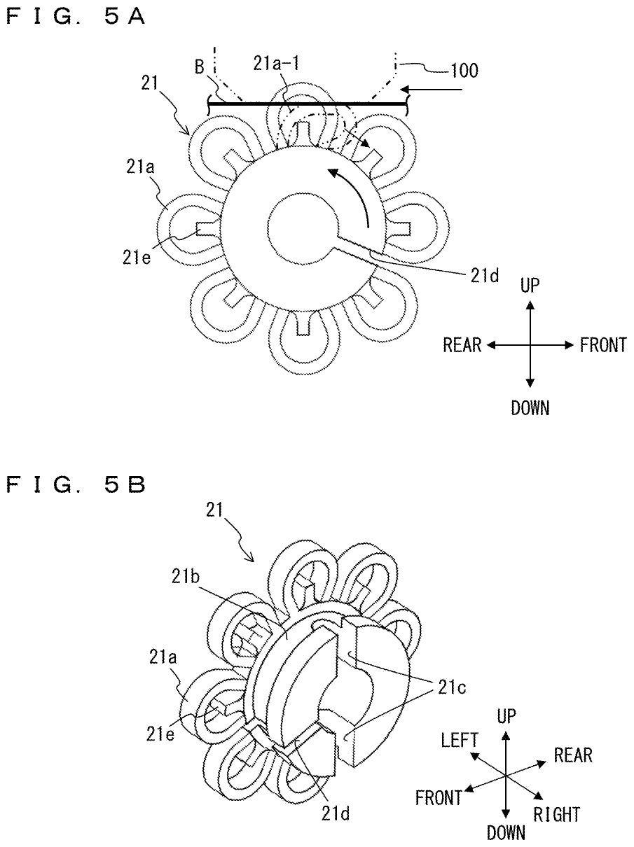

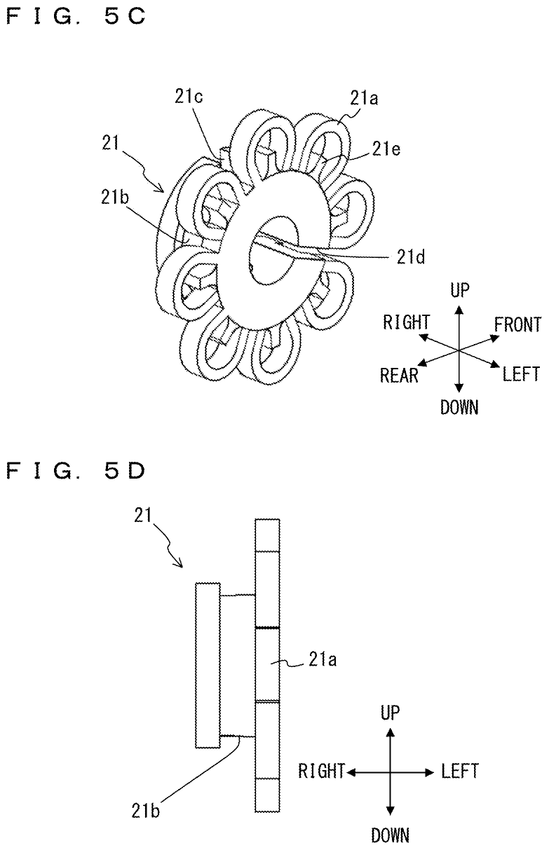

FIGS. 5A-5D are a left side view, a right-side perspective view, a left-side perspective view, and a back view illustrating a transportation member 21.

Components similar to the paper sheet handling apparatus 1 depicted in FIGS. 1-2B and the rotation shaft member 12 and the transportation roller 13 depicted in FIGS. 3A and 3B, i.e., components in the first embodiment, can be used in a second embodiment. Accordingly, the second embodiment will be described herein by focusing mainly on differences between the transportation member 11 in accordance with the first embodiment and the transportation member 21 in accordance with the second embodiment.

The transportation member 21 includes, as depicted in FIGS. 5A-5C, a plurality of (e.g., eight) elastic loop sections 21a and transports a bill B depicted in FIG. 5A.

The plurality of loop sections 21a each have a loop supporting section 21e provided inside thereof. The loop supporting section 21e protrudes outward in the radial direction of the transportation member 21 and reaches the vicinity of the center (central axis) of the loop section 21a.

As depicted in FIG. 5A, the plurality of loop sections 21a are arranged in the rotation direction of the transportation member 21 such that the plurality of loop sections 21a are each supported by a loop supporting section 21e and an adjacent loop section 21a when being elastically deformed (see the loop section 21a-1 indicated by two-dot dash lines) while contacting a bill B sandwiched between the loop section 21a and a magnetic line sensor 100 indicated by a two-dot dash line.

As depicted in FIGS. 5B and 5D, the transportation member 21 is provided with a bundling groove 21b. A bundling member such as a bundling band (not illustrated) is inserted into the bundling groove 21b. The bundling member fixes the transportation member 21 to the rotation shaft member 12 depicted in FIGS. 3A and 3B by being wound in the bundling groove 21b.

As depicted in FIG. 5B, the right side surface of the transportation member 21 is provided with a positioning groove 21c extending in the radial direction (the up-down direction in FIG. 5B) across the transportation member 21. Two positioning pins 12a protruding from the rotation shaft member 12 depicted in FIG. 3B toward opposite sides are inserted into the positioning groove 21c. Thus, the transportation member 21 rotates integrally with the rotation shaft member 12 with the positioning thereof in the rotation direction attained with respect to the rotation shaft member 12.

As depicted in FIGS. 5A and 5C, the transportation member 21 is provided with a notch 21d for allowing the transportation member 21 to be attached to the rotation shaft member 12 in a detachable manner. Two portions of the transportation member 21 sandwiching the notch 21d are separated in the rotation direction.

The second embodiment can exhibit similar effects to the first embodiment in terms of similar matters, e.g., the effect wherein a loop section 21a supported by an adjacent loop section 21a can transport a bill B while being elastically deformed, so that the transportation member 21 can transport the bill B with a high transporting force.

In the second embodiment, the transportation member 21 further includes the loop supporting sections 21e provided inside the loop sections 21a, and the loop supporting sections 21e each support a loop section 21a when the loop section 21a is elastically deformed while contacting a bill B. Thus, the loop section 21a can be supported not only by an adjacent loop section 21a but also by the loop supporting section 21e, so that the bill B can be transported with a higher transporting force.

### Third Embodiment

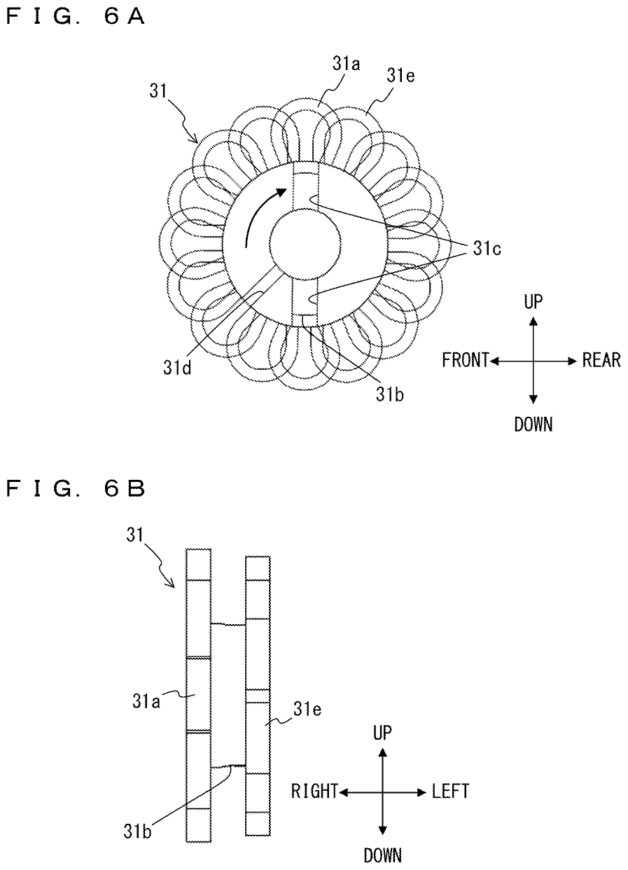

FIGS. 6A and 6B are a right side view and a back view illustrating a transportation member 31.

Components similar to the paper sheet handling apparatus 1, the rotation shaft member 12, and the transportation roller 13, i.e., components in the first embodiment, can be used in a third embodiment. Accordingly, the third embodiment will be described herein by focusing mainly on differences between the transportation member 11 in accordance with the first embodiment and the transportation member 31 in accordance with the third embodiment.

As depicted in FIGS. 6A and 6B, the transportation member 31 includes: a plurality of (e.g., eight) first loop sections 31a arranged in a rotation direction; and a plurality of (e.g., eight) second loop sections 31e arranged in the rotation direction and spaced apart from the plurality of first loop sections 31a in a direction parallel to the rotation shaft member 12 depicted in FIGS. 3A and 3B, i.e., the left-right direction.

The plurality of first loop sections 31a are each provided on the center between two second loop sections 31e in the rotation direction of the transportation member 31. Thus, the plurality of first loop sections 31a may be provided at positions shifted with reference to the plurality of second loop sections 31e in the rotation direction.

At least either the first loop sections 31a or the second loop sections 31e may each have provided inside thereof the loop supporting section 21e described above by referring to the second embodiment.

The plurality of loop sections 31a are, as depicted in FIG. 6A, arranged in the rotation direction of the transportation member 31 such that the plurality of loop sections 31a are each supported by an adjacent loop section 31a when being elastically deformed while contacting a bill B sandwiched between the loop section 31a and the magnetic line sensor 100 indicated by a two-dot dash line in FIG. 4A and the like.

Likewise, the plurality of second loop sections 31e are arranged in the rotation direction of the transportation member 31 such that the plurality of second loop sections 31e are each supported by an adjacent second loop section 31e when being elastically deformed while contacting a bill B sandwiched between the second loop section 31e and the magnetic line sensor 100.

As depicted in FIG. 6B, the transportation member 31 is provided with a bundling groove 31b. A bundling member such as a bundling band (not illustrated) is inserted into the bundling groove 31b. The bundling member fixes the transportation member 31 to the rotation shaft member 12 depicted in FIGS. 3A and 3B by being wound in the bundling groove 31b.

As depicted in FIG. 6A, the right side surface of the transportation member 31 is provided with a positioning groove 31c extending in the radial direction (the up-down direction in FIG. 6A) across the transportation member 31. Two positioning pins 12a protruding from the rotation shaft member 12 depicted in FIG. 3B toward opposite sides are inserted into the positioning groove 31c. Thus, the transportation member 31 rotates integrally with the rotation shaft member 12 with the positioning thereof in the rotation direction attained with respect to the rotation shaft member 12.

As depicted in FIG. 6A, the transportation member 31 is provided with a notch 31d for allowing the transportation member 31 to be attached to the rotation shaft member 12 in a detachable manner. Two portions of the transportation member 31 sandwiching the notch 31d are separated in the rotation direction.

The third embodiment can exhibit similar effects to the first embodiment in terms of similar matters, e.g., the effect wherein the loop section supported by an adjacent loop section (a first loop section 31a or a second loop section 31e) can transport a bill B while being elastically deformed, so that the transportation member 31 can transport the bill B with a high transporting force.

In the third embodiment, the plurality of loop sections of the transportation member 31 include: the plurality of first loop sections 31a arranged in the rotation direction; and the plurality of second loop sections 31e arranged in the rotation direction and spaced apart from the plurality of first loop sections 31a in a direction parallel to the rotation shaft member 12, and the plurality of first loop sections 31a are provided at positions shifted with reference to the plurality of second loop sections 31e in the rotation direction. Thus, a bill B can be transported not only by a first loop section 31a supported by an adjacent first loop section 31a but also by a second loop section 31e supported by an adjacent second loop section 31e, so that the bill B can be transported with a higher transporting force.

In the first embodiment (the second and third embodiments), although only one loop section 11a (only one loop section 21a, and only one first loop section 31a and only one second loop section 31e) is provided in the radial direction of the transportation member 11 (the transportation members 21 and 31), a plurality of continuous loop sections 11a (a plurality of continuous loop sections 21a, and a plurality of continuous first loop sections 31a and a plurality of continuous second loop sections 31e) may be provided in the radial direction and the rotation direction of the transportation member 11 (the transportation members 21 and 31), thereby forming, for example, a honeycomb geometry.

The present invention is not simply limited to the first to third embodiments. Components of the embodiments may be embodied in a varied manner in an implementation phase without departing from the gist of the invention. A plurality of components disclosed with reference to the first to third embodiments may be combined, as appropriate, to achieve various inventions. For example, all of the components indicated with reference to the first to third embodiments may be combined, as appropriate. Accordingly, various variations and applications of the invention can be provided without departing from the gist of the invention.

1. A paper sheet handling apparatus comprising:
a transportation member that transports a paper sheet; and
a rotation shaft member that serves as a center of rotation of the transportation member, wherein
the transportation member includes a plurality of elastic loop sections having central axes parallel to the rotation shaft member, and
the plurality of loop sections are arranged in a rotation direction of the transportation member such that the plurality of loop sections are each supported by an adjacent loop section when being elastically deformed while contacting the paper sheet.

2. The paper sheet handling apparatus of claim 1, further comprising:
a transportation roller that rotates together with the transportation member, with the rotation shaft member as a center of rotation, wherein
the plurality of loop sections protrude in a radial direction beyond an outer peripheral surface of the transportation roller.

3. The paper sheet handling apparatus of claim 1, wherein
the transportation member is provided with a notch for allowing the transportation member to be attached to the rotation shaft member in a detachable manner, and two portions of the transportation member sandwiching the notch are separated in the rotation direction.

4. The paper sheet handling apparatus of claim 1, wherein
the transportation member further includes loop supporting sections provided inside the loop sections, and
the loop supporting sections each support a loop section when the loop section is elastically deformed while contacting the paper sheet.

5. The paper sheet handling apparatus of claim 1, wherein
the plurality of loop sections include a plurality of first loop sections arranged in the rotation direction and a plurality of second loop sections arranged in the rotation direction and spaced apart from the plurality of first loop sections in a direction parallel to the rotation shaft member, and
the plurality of first loop sections are provided at positions shifted with reference to the plurality of second loop sections in the rotation direction.

6. A transportation member for transporting a paper sheet, the transportation member comprising:
a plurality of elastic loop sections having central axes parallel to a rotation shaft member that serves as a center of rotation of the transportation member, wherein
the plurality of loop sections are arranged in a rotation direction of the transportation member such that the plurality of loop sections are each supported by an adjacent loop section when being elastically deformed while contacting the paper sheet.
